(19) United States
(12) Patent Application Publication
(10) Pub. No.: US 2009/0185382 A1
(43) Pub. Date: Jul. 23, 2009

(54) Light Cover Structure

(75) Inventor: Tzyy-Yu Chiang, Taipei (TW)

Correspondence Address: SHOEMAKER AND MATTARE, LTD, 10 POST OFFICE ROAD - SUITE 100, SILVER SPRING, MD, 20910, US

(73) Assignee: EKPAC TAIWAN LIMITED, Taipei (TW)

(21) Appl. No.: 12/016,512

(22) Filed: Jan. 18, 2008

(51) Int. Cl. F21V 7/00

(52) U.S. Cl. 362/310

(57) ABSTRACT

A light cover structure includes a bulb holder having a reflecting portion; a shield element in front of the bulb holder; a light reflecting element on the shield element; and a cover body in front of the bulb holder. Light emitted from the bulb module is reflected by the reflecting portion of the bulb holder and part of the reflected light is shielded by the shield element. What would otherwise be stray light is reflected by the light reflecting element. Light that is not shielded by the shield element and the reflected stray light pass through the inside of the cover body and reach the light transmission element so that they can be concentrated and transmitted out of the light cover structure by the light transmission element, thereby forming light having a light pattern corresponding to the shield element and light pattern of the stray light reflected by the light reflecting element.

### BACKGROUND OF THE INVENTION

1. Field of the Invention

The present invention relates generally to a light cover structure, and more particularly to a light cover structure for vehicles having a light reflecting element for reflecting stray light emitted from a light bulb so as to direct the stray light to road signs down the road.

2. Description of Related Art

Light covers for vehicles allow drivers to have a clear view of the road especially at night and in bad weather and alert other motorists or pedestrians to vehicle activity.

However, if the light emitted through light covers is too intense, oncoming drivers can have their eyes dazzled or temporarily blinded by such light. On the other hand, if the light emitted through light covers is too weak, it is difficult for drivers to have a clear view of the road profile and signs down the road, thereby causing a hazard.

Due to the above drawbacks, a light cover for vehicles has been proposed, wherein a semicircular shield plate is disposed at the front of the bulb holder and a lower portion of the front end of the convex lens is patterned such that light emitted from the bulb and reflected by the reflecting surface inside the bulb holder only illuminates the road surface and road signs. However, there is some difficulty in patterning the convex lens and the cost is also high.

Therefore, providing a light cover structure that can guide stray light emitted from a light bulb to road signs down the road is highly desirable.

### SUMMARY OF THE INVENTION

Based on the above drawbacks, an objective of the present invention is to provide a light cover structure capable of radiating light emitted from the bulb to road signs down the road.

In order to attain the above and other objectives, the present invention discloses a light cover structure, which comprises: a bulb holder disposed around the bulb module and having a reflecting portion; a shield element disposed at the front end of the bulb holder; a light reflecting element disposed on the shield element; and a cover body disposed at the front end of the bulb holder, the cover body having a light transmission element disposed at the front end thereof at a predefined distance away from the shield element and corresponding to the bulb module; wherein light emitted from the bulb module is reflected by the reflecting portion of the bulb holder and part of the reflected light is shielded by the shield element, and, meanwhile, what would otherwise be stray light emitted from the bulb module is reflected by the light reflecting element, wherein light that is not shielded by the shield element and the reflected stray light pass through the inside of the cover body and reach the light transmission element such that the light that is not shielded by the shield element and the reflected stray light can be concentrated and transmitted out of the light cover structure by the light transmission element, thereby forming light having a light pattern corresponding to the shield element and the light pattern imparted to the stray light reflected by the light reflecting element.

Accordingly, what would otherwise be stray light emitted from the bulb module can be more concentrated to a central position by the light reflecting element and further be directed to road signs. Thus, characters and symbols on road signs are more clearly visible to the driver of a vehicle so equipped, and, meanwhile oncoming drivers don't have their vision impaired by radiated light that is too strong or misdirected.

### BRIEF DESCRIPTION OF DRAWINGS

FIG. 1 is an exploded diagram of a light cover structure according to the present invention;

FIG. 2 is a diagram of light reflection in the light cover structure according to the present invention;

FIG. 3A is a light projection diagram of a vehicle having the light cover structure according to the present invention;

FIG. 3B is a light projection pattern diagram of the light cover structure according to the present invention;

FIG. 4 is a light test quadrant diagram of the light pattern of the light cover structure according to the present invention; and

FIG. 5 is a table showing a light-match test standard for the light cover structure according to the present invention.

### DETAILED DESCRIPTION OF PREFERRED EMBODIMENTS

The following illustrative embodiments are provided to illustrate the disclosure of the present invention, wherein these and other advantages and effects can be apparent to those skilled in the art after reading the disclosure of this specification.

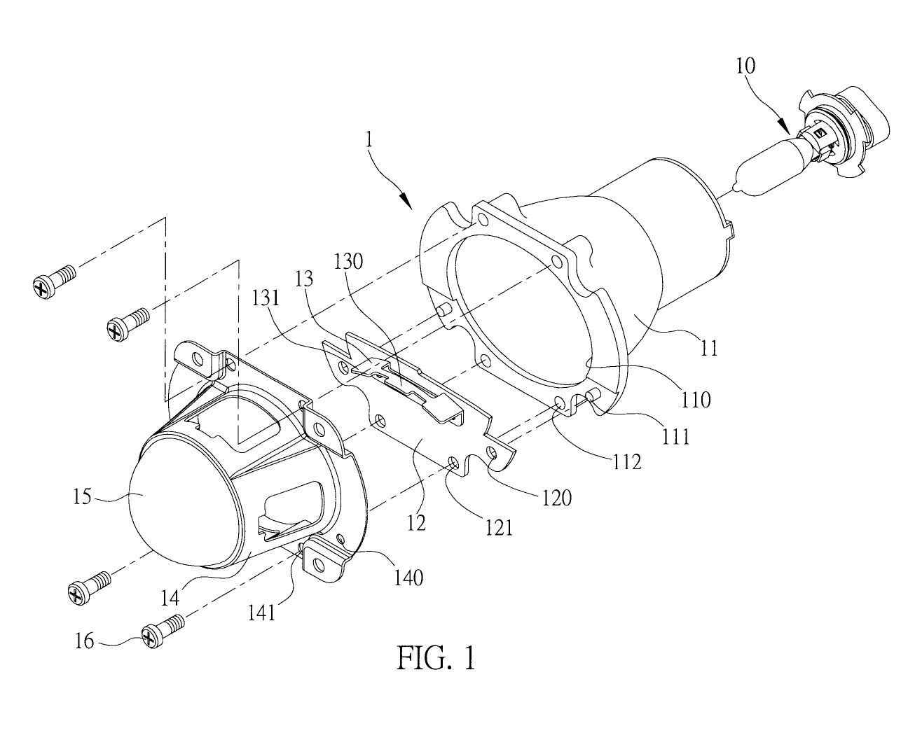

FIG. 1 is an exploded diagram of a light cover structure according to the present invention.

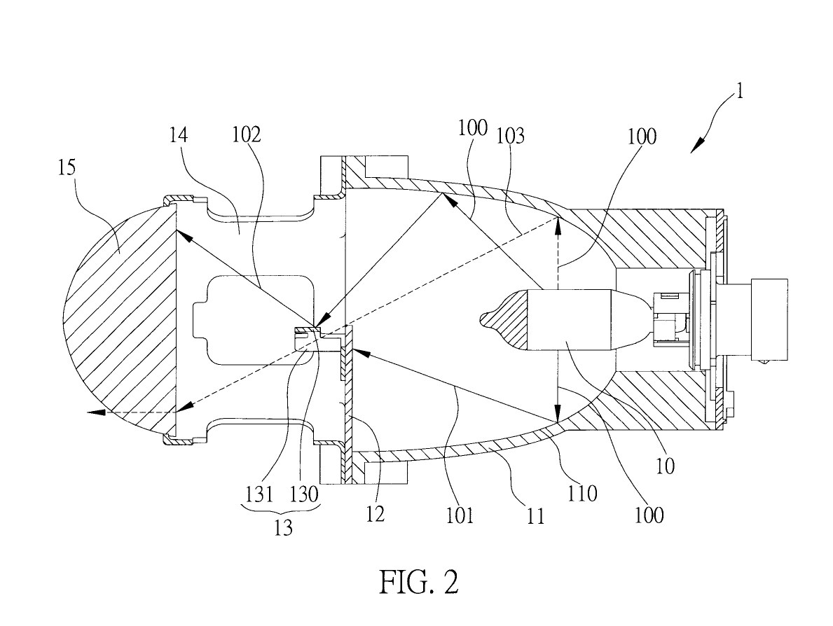

Referring to FIG. 1, the light cover structure 1 is applied to a bulb module 10. The light cover structure 1 comprises: a bulb holder 11 disposed around the bulb module 10 and having a reflecting portion 110; a shield element 12 disposed at the front end of the bulb holder 11; a light reflecting element 13 disposed on the shield element 12; and a cover body 14 disposed at the front end of the bulb holder 11, the cover body 14 having a light transmission element 15 disposed at the front end thereof at a predefined distance away from the shield element 12 and corresponding to the bulb module 10; wherein, as shown in FIG. 2, light 100 emitted from the bulb module 10 is reflected by the reflecting portion 110, and part of the reflected light 101 is shielded by the shield element 12, and, meanwhile, what would otherwise be stray light emitted from the bulb module 10 is reflected by the light reflecting element 13, wherein light 103 that is not shielded by the shield element 12 and the reflected stray light 102 reflected by the light reflecting element 13 pass through the inside of the cover body 14 and reach the light transmission element 15 such that the light 103 that is not shielded by the shield element 12 and the stray light 102 reflected by the light reflecting element 13 can be concentrated by the light transmission element 15 and transmitted out of the light cover structure 1, thereby forming light having a light pattern corresponding to the shield element 12 and the light pattern imparted to the stray light 102 reflected by the light reflecting element 13.

In the present embodiment, the stray light 102 is light that is emitted from the bulb module 10 and reflected by the reflecting portion 110 of the bulb holder 11 but would otherwise not reach the light transmission element 15 without the invention. The bulb holder 11 has a plurality of positioning columns 111; the shield element 12 has a plurality of first positioning holes 120 corresponding to the positioning columns 111; and the cover body 14 has a plurality of second positioning holes 140 corresponding to the positioning columns 111 and the first positioning holes 120 such that the positioning columns 111 of the bulb holder 11 can be inserted into the first positioning holes 120 and the second positioning holes 140, thereby positioning the shield element 12 and the cover body 14 onto the bulb holder 11. The light cover structure 1 further comprises a plurality of combining elements 16, wherein the bulb holder 11 has a plurality of combining portions 112 corresponding to the combining elements 16, the shield element 12 has a plurality of first through portions 121 corresponding to the combining elements 16, and the cover body 14 has a plurality of second through portions 141 corresponding to the combining elements 16. Thus, the combining elements 16 can be passed through the first through portions 121 and the second through portions 141 and combined with the combining portions 112, thereby fixing the shield element 12 and the cover body 14 to the bulb holder 11. The combining elements 16 can be screws and the combining portions 112 can be screw holes. The first through portions 121 and the second through portions 141 are through holes. The shield element 12 is one of a galvanized steel sheet, an aluminum alloy sheet and a stainless steel sheet. The light reflecting element 13 has a light reflecting portion 130 at a central position of the front end thereof for reflecting the stray light emitted from the bulb module 10. A plurality of supporting portions 131 is formed at two opposite sides of the light reflecting portion 130 for supporting the light reflecting element 13 that is disposed on the shield element 12. The light reflecting element 13 is substantially L-shaped and central portion of the light reflecting element 13 is hollow. The light reflecting portion 13 is one of a galvanized steel sheet, an aluminum alloy sheet and a stainless steel sheet. The light transmission element 15 is a convex lens.

The principles and function of the present invention are detailed as follows. The light cover structure 1 of the present invention is applied to a bulb module 10. A bulb holder 11 is disposed around the bulb module 10 and comprises a reflecting portion 110, a plurality of positioning columns 111 and a plurality of combining portions 112 such as screw holes. A shield element 12 is disposed at the front end of the bulb holder 11 and comprises a plurality of first positioning holes 120 and a plurality of first through portions 121 such as through holes. A light reflecting element 13 is fixed to the shield element 12 by rivets or another fastening method, wherein the light reflecting element 13 is substantially L-shaped and central portion of the light reflecting element 13 is hollow. The light reflecting element 13 has a light reflecting portion 130 at a central position of the front end thereof for reflecting what would otherwise be stray light emitted from the bulb module 10. Further, a plurality of supporting portions 131 is formed at two opposite sides of the light reflecting portion 130 for supporting the light reflecting element 13 that is disposed on the shield element 12. A cover body 14 is disposed at the front end of the bulb holder 11 and comprises a plurality of second positioning holes 140, a plurality of second through portions 141 such as through holes. The cover body 14 further comprises a light transmission element 15 such as a convex lens disposed at the front end thereof at a predefined distance away from the shield element 12 and corresponding to the bulb module 10. The positioning columns 111 of the bulb holder 11 are inserted into the first positioning holes 120 of the shield element 12 and the second positioning holes 140 of the cover body 14 so as to position the shield element 12 and the cover body 14 onto the bulb holder 11. Moreover, combining elements 16, such as screws, are passed through the second through portions 141 of the cover body 14 and the first through portions 121 of the shield element 12 and combined with the combining portions 112 of the bulb holder 11, such as screw holes, so as to fix the shield element 12 and the cover body 14 to the bulb holder 11. The light transmission element 15 is an optically transparent element such as a convex lens. Light emitted from the bulb module 10 is reflected by the reflecting portion 110 and part of the reflected light is shielded by the shield element 12. Meanwhile, what would otherwise be stray light emitted from the bulb module 10 and reflected by the reflecting portion 110 is reflected by the light reflecting element 13. Thus, light that is not shielded by the shield element 12 and the reflected stray light reflected by the light reflecting element 13 pass through the inside of the cover body 14 and reach the light transmission element 15 such that the light that is not shielded by the shield element 12 and the reflected stray light reflected by the light reflecting element 13 can be concentrated and transmitted out of the light cover structure 1, thereby forming light having a light pattern corresponding to the shield element 12 and the light pattern imparted to the reflected stray light reflected by the light reflecting element 13.

FIG. 2 is a diagram of light reflection in the light cover structure according to the present invention.

Referring to FIG. 2, the bulb holder 11 of the light cover structure 1 is disposed around the bulb module 10 and connected to the power supply such that the bulb module 10 can emit light 100 that is further reflected by the reflecting portion 110 of the bulb holder 11. Part of the light 101 reflected by the lower half of the reflecting portion 110 of the bulb holder 10 is shielded by the shield element 12. Light that is reflected by the upper half of the reflecting portion 110 of the bulb holder 11 that is not shielded by the shield element 12 passes through inside of the cover body 14 and is transmitted out of the light cover structure 1 by the light transmission element 15 and radiated outward to the road surface. What would otherwise be stray light 102 is light that is emitted from the bulb module 10 and reflected by the reflecting portion 110 to the light reflecting portion 130 of the light reflecting element 13 and further reflected by the light reflecting portion 130. The reflected stray light 102 passes through the inside of the cover body 14 and is transmitted out of the light cover structure 1 by the light transmission element 15 and radiated onto road. Oncoming drivers' views are not affected by this radiated light.

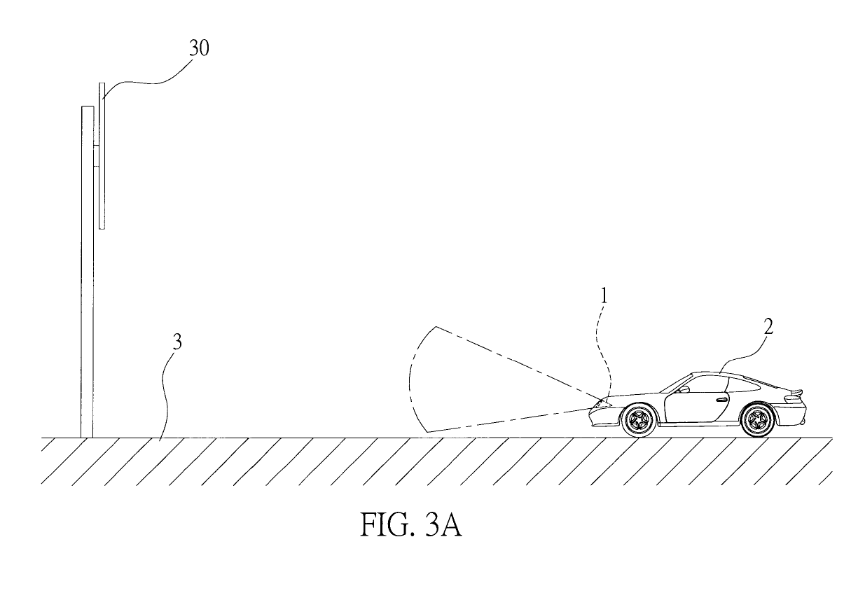

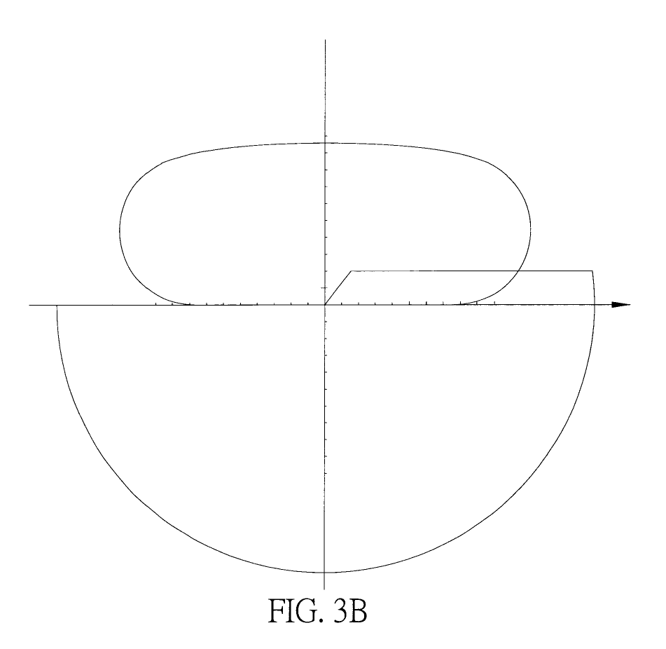

FIG. 3A is a light projection diagram of a vehicle having the light cover structure 1 according to the present invention. Referring to FIG. 2 in combination with 3A, the light cover structure 1 is disposed on a vehicle 2 and connected to the power unit of the vehicle. When the light cover structure 1 is used at night or in bad weather, part of the light 101 emitted from the bulb module 10 and reflected by the reflecting portion 110 of the bulb holder 11 is shielded by the shield element 12; the reflected stray light 102 that is reflected by the reflecting portion 110 of the bulb holder 11 to the light reflecting portion 130 of the light reflecting element 13 and further reflected by the light reflecting portion 130 is transmitted through the light transmission element 15 and radiated outward onto roads sign 30; non-shielded light 103 that is reflected by the reflecting portion 110 of the bulb holder 11 and passes above the shield element 12 is transmitted through the light transmission element 15 and radiated onto the road surface 3. The reflected stray light 102 and the non-shielded light 103 are not projected into oncoming drivers' view of and accordingly do not adversely affect safe driving conditions for oncoming vehicles.

FIG. 3B is a light projection pattern diagram of the light cover structure according to the present invention. Referring to FIGS. 2 and 3B in combination, when the bulb module 10 of the light cover structure 1 is connected to the power supply, light 100 emitted from the bulb module 10 is reflected by the reflecting portion 110 of the bulb holder 11, and part of the light 101 reflected by the lower half reflecting portion is shielded by the shield element 12. What would otherwise be stray light 102 emitted from the bulb module 10 and reflected by the reflecting portion 110 to the light reflecting portion 130 of the light reflecting element 13 and further reflected by the light reflecting portion 130 is transmitted out of the light cover structure 1 by the light transmission module 10 and forms the oval area at the top of FIG. 3B above the central horizontal line. Non-shielded light 103 that is emitted from the bulb module 10 and reflected by the reflecting portion 110 of the bulb holder 11 without being shielded by the shield element 12 is transmitted through the light transmission element 15 and radiated below the central horizontal line of FIG. 3B. Thus, the stray light 102 and the non-shielded light 103 form the light pattern of FIG. 3B.

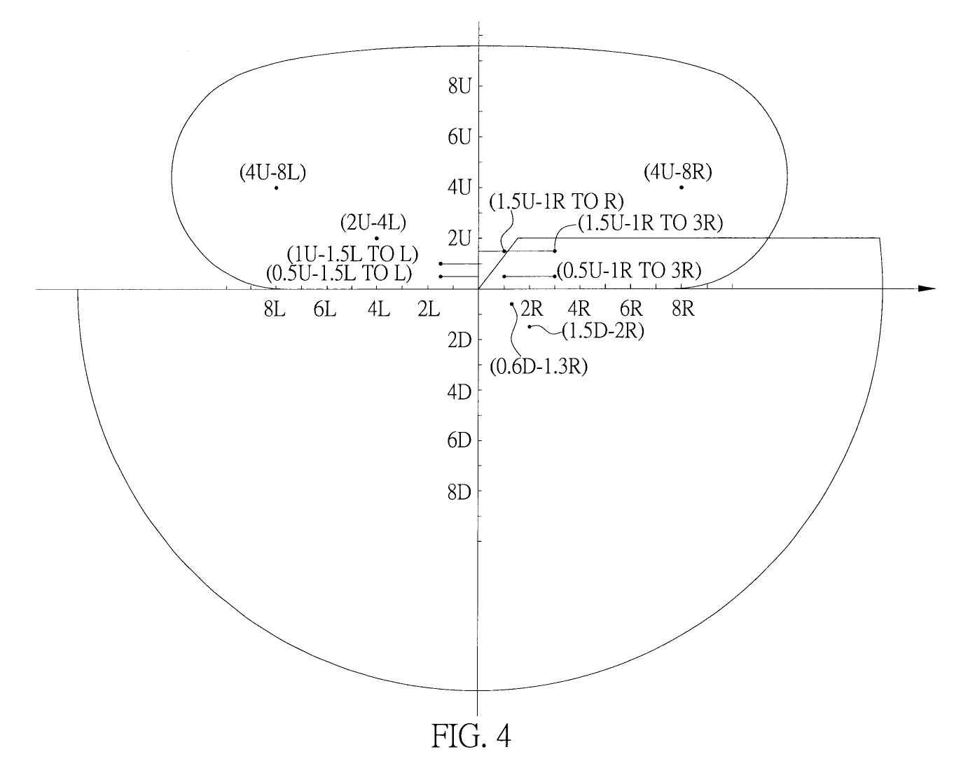

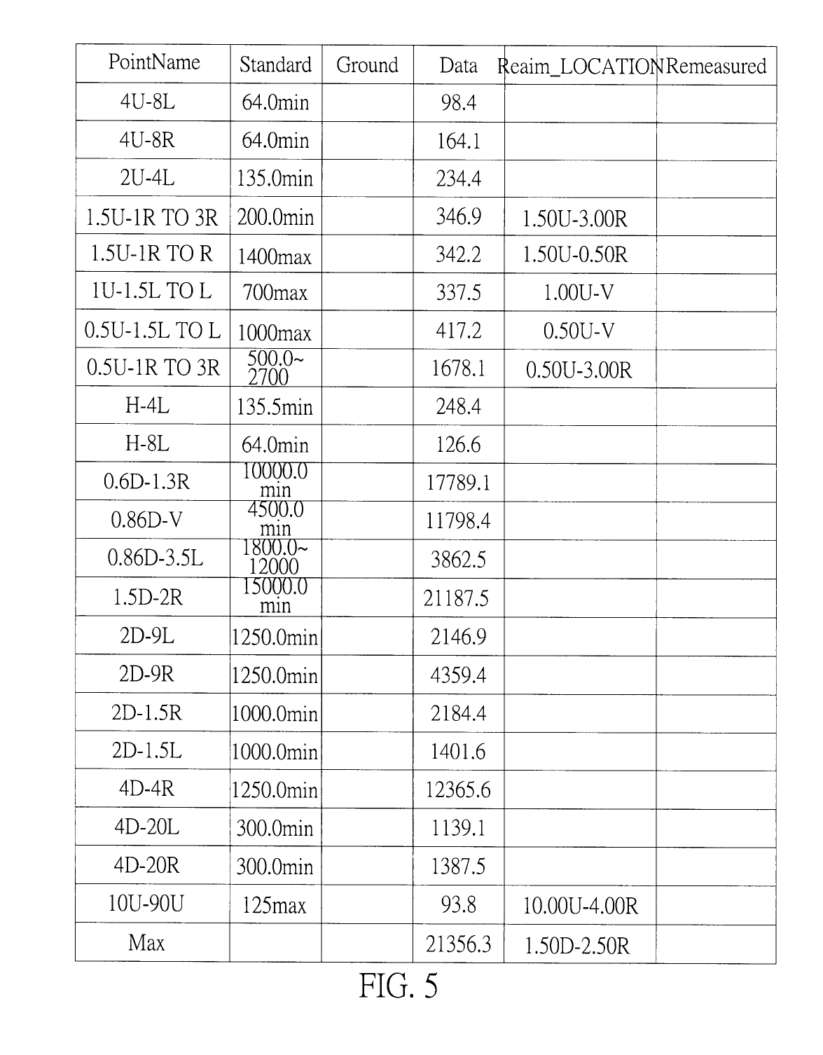

FIG. 4 is a light test quadrant diagram of the light cover structure according to the present invention. The test complies with the light-match test standard of FIG. 5, at a test distance of 25 meters. The light cover structure 1 is disposed around the bulb module 10 and connected to 12 volt power supply such that light 100 can be emitted from the bulb module 10. The light 100 is reflected by the reflecting portion 110 of the bulb holder 11 and then reflected by the reflecting portion 130 of the light reflecting element 13 such that stray light 102 can be formed and tested, wherein the following measurements apply:

measured brightness of the stray light 102 at point (4 U, 8 L) is at least not smaller than 64.0 candela;

measured brightness of the stray light 102 at point (4 U, 8 R) is at least not smaller than 64.0 candela;

measured brightness of the stray light 102 at point (2 U, 4 L) is at least not smaller than 135.0 candela;

measured brightness of the stray light 102 between (1.5 U, 1 R) and (1.5 U, 3 R) is at least not smaller than 200.0 candela;

measured brightness of the stray light 102 between (1.5 U, 1 R) and (1.5 U, R) is not bigger than 1400 candela;

measured brightness of the stray light 102 between (1 U, 1.5 L) and (1 U, L) is not bigger than 700 candela;

measured brightness of the stray light 102 between (0.5 U, 1.5 L) and (0.5 U, L) is not bigger than 1000 candela; and

measured brightness of the stray light 102 between (0.5 U, 1 R) and (0.5 U, 3 R) is between 500.0 candela and 2700 candela; and

measured brightness of the stray light 102 reflected by the light reflecting portion 130 has a preferred standard value range between 64.0 and 135.0 candela such that the stray light 102 can be radiated to road signs so as to make characters and symbols on road signs more clearly visible to drivers.

The light 100 is reflected by the reflecting portion 110 and non-shielded light 103 is obtained. The non-shielded light 103 was tested and found to have the following measurements:

measured brightness of the non-shielded light 103 at point (0.6 D, 1.3 R) is at least not smaller than 10000.0 candela, and measured brightness of the non-shielded light 103 at point (1.5 D, 2 R) is at least not smaller than 15000.0 candela.

Therefore, the light cover structure of the present invention has a light reflecting element disposed on the shield element for reflecting what would otherwise be stray light that is emitted from the bulb module, reflecting such light by the reflecting portion of the bulb holder such that the stray light can be radiated onto road signs, rather than into the path of oncoming drivers. Thus, an oncoming drivers' view is not affected and, meanwhile, characters and symbols on the road signs are more clearly visible to the driver of the vehicle equipped with the invention.

The above-provided descriptions of the detailed embodiments are only to illustrate the preferred implementation according to the present invention, and are not intended to limit the scope of the present invention. Accordingly, various modifications and variations completed by those with ordinary skill in the art consistent with the following appended claims should fall within the scope of present invention.

What is claimed is:

1. A light cover structure applied to a bulb module, comprising:
a bulb holder disposed around the bulb module and having a reflecting portion;
a shield element disposed at the front end of the bulb holder;
a light reflecting element disposed on the shield element; and
a cover body disposed at the front end of the bulb holder, the cover body having a light transmission element disposed at the front end thereof at a predefined distance away from the shield element and corresponding to the bulb module;
wherein light emitted from the bulb module is reflected by the reflecting portion of the bulb holder and part of the reflected light is shielded by the shield element, and, meanwhile, what would otherwise be stray light emitted from the bulb module is reflected by the light reflecting element, wherein light that is not shielded by the shield element and the reflected stray light pass through the inside of the cover body and reach the light transmission element such that the light that is not shielded by the shield element and the reflected stray light can be concentrated and transmitted out of the light cover structure by the light transmission element, thereby forming light having a light pattern corresponding to the shield element and light pattern imparted to the stray light reflected by the light reflecting element.

2. The light cover structure of claim 1, wherein the stray light is light that is emitted from the bulb module and reflected by the reflecting portion of the bulb holder but would otherwise not reach the light transmission element without the invention.

3. The light cover structure of claim 1, wherein the bulb holder has a plurality of positioning columns, the shield element has a plurality of first positioning holes corresponding to the positioning columns of the bulb holder, and the cover body has a plurality of second positioning holes corresponding to the positioning columns of the bulb holder and the first positioning holes of the shield element, wherein the plurality of positioning columns of the bulb holder are inserted through the first positioning holes and the second positioning holes so as to position the shield element and the cover body to the bulb holder.

4. The light cover structure of claim 1 further comprising a plurality of combining elements, wherein the bulb holder has a plurality of combining portions corresponding to the combining elements, the shield element has a plurality of first through portions corresponding to the combining elements, and the cover body has a plurality of second through portions corresponding to the combining elements, wherein the combining elements are passed through the first through portions and the second through portions and combined with the combining portions so as to fix the shield element and the cover body to the bulb holder.

5. The light cover structure of claim 4, wherein the combining elements are screws.

6. The light cover structure of claim 4, wherein the combining portions are screw holes.

7. The light cover structure of claim 4, wherein the first through portions are through holes.

8. The light cover structure of claim 4, wherein the second through portions are through holes.

9. The light cover structure of claim 1, wherein the shield element is one of a galvanized steel sheet, an aluminum alloy sheet and a stainless steel sheet.

10. The light cover structure of claim 1, wherein the light reflecting element has a light reflecting portion at a central position of the front end thereof for reflecting what would otherwise be stray light emitted from the bulb module.

11. The light cover structure of claim 10, wherein a plurality of supporting portions is formed at two opposite sides of the light reflecting portion of the light reflecting element for supporting the light reflecting element that is disposed on the shield element.

12. The light cover structure of claim 11, wherein the light reflecting element is substantially L-shaped.

13. The light cover structure of claim 11, wherein the central portion of the light reflecting element is hollow.

14. The light cover structure of claim 1, wherein the light reflecting element is one of a galvanized steel sheet, an aluminum alloy sheet and a stainless steel sheet.

15. The light cover structure of claim 1, wherein the light transmission element is a convex lens.

16. The light cover structure of claim 1, wherein the light reflecting element is substantially L-shaped.

17. The light cover structure of claim 1, wherein the central portion of the light reflecting element is hollow.
